(19) United States
(12) Patent Application Publication
(10) Pub. No.: US 2007/0202008 A1
(43) Pub. Date: Aug. 30, 2007

(54) Systems and methods of lipoprotein size fraction assaying

(76) Inventors: Carol T. Schembri, San Mateo, CA (US); May Tom-Moy, San Carlos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/364,267

(22) Filed: Feb. 28, 2006

(51) Int. Cl. G01N 21/00

(52) U.S. Cl. 422/57

(57) ABSTRACT

Systems and methods for nanopore flow cells are provided.

### BACKGROUND

Lipids have many important functions in biology including being fuel sources, acting as structural components in cellular membranes, serving as hormones, and preventing heat loss. As a necessary component of every cell, they are transported throughout the body. Since lipids are generally not water soluble, the body packages them into micelles with a hydrophilic coating to facilitate transport through the circulatory system. These micelles or lipoproteins are filled with fatty acids and triglycerides and coated with cholesterol, phospholipids, and specialized proteins called apolipoproteins. Shown in FIG. 1 is a schematic representation of an exemplary lipoprotein structure that is depicted as a neutral lipid core of cholesterol ester (CE) and triglyceride (TG) surrounded by a shell consisting of phospholipids (PL) and free (unesterified) cholesterol (FC).

There are several types of lipoproteins present in human blood, including low-density lipoproteins (LDL)—large molecules containing approximately 20% protein- and high-density lipoproteins (HDL)—smaller cells containing about 50% protein. LDLs are the main transport for cholesterol through the body. HDLs appear to carry excess cholesterol to the liver for processing. Studies have found that high levels of HDLs, which seem to retard or even reverse the formation of cholesterol plaque in the arteries, reduce the risk of cardiovascular disease. Cell membranes are essentially lipoprotein in nature; the membrane is a continuous sheet of lipid molecules, largely phospholipids, in close association with proteins that either face one side of the membrane or penetrate all the way through the membrane.

Lipoproteins are very small particles as shown below in Table 1, which information is available from Burtis, Carl A., et al., Tietz Textbook of Clinical Chemistry, 2nd edition, p 1024.

TABLE 1
Characteristics of Various Lipoproteins

| | Hydrated | | | |
|---|---|---|---|---|
| | Density | Diameter | | |
| Particle | (kg/L) | (nm) | % triglyceride | % protein |
| Chylomicron | 0.93 | >70 | 84 | 2 |
| VLDL | 0.97 | 25-70 | 44-60 | 4-11 |
| IDL | 1.003 | 22-24 | 30 | 15 |
| LDL | 1.034 | 19.6-22.7 | 11 | 20 |
| HDL | 1.121 | 4-10 | 3 | 50 |

By comparison, cells are typically measured in the micron range. Platelets, among the smallest of cells, are about 3 microns in diameter.

In the 1950's and 1960's scientists at the Lawrence Berkeley National Laboratories (LBNL) discovered that lipoproteins could be classified and separated based on their density. Lipoproteins are now classified as chylomicrons, VLDL (very low density lipoprotein), IDL (intermediate density), LDL (low density), and HDL (high density). Within each classification, there are further subclasses.

As noted above, at least some lipoproteins have long been associated with coronary artery disease. Numerous studies within the last decade have demonstrated that specific subclasses of lipoproteins are associated with disease progression while others are associated with disease regression. U.S. Pat. No. 5,925,229 to Knauss et al. describe a segmented gradient gel electrophoresis assay that separates and quantitates subfractions of lipoproteins far more conveniently than the previously-used analytical ultracentrifugation process. The segmented gradient gel electrophoretic technology is used to provide personalized analysis of patients' lipid profiles. This assay, however, requires precise construction of the gradient gel, many hours of electrophoretic separation followed by careful fixing, staining, and densitometer measurement of the gel to obtain a measurement. Ideally, there would be a faster, lower cost method to make this measurement.

### SUMMARY

Systems and methods for nanopore flow cells are provided. One such nanopore analysis system, among others, includes a nanopore flow cell including a cell reservoir, at least one fluid flow channel, an electrode, and a nanopore aperture. The cell reservoir is in fluid communication with the fluid flow channel. The nanopore aperture is in fluid communication with the cell reservoir. The cell reservoir is in fluid communication with the electrode. The nanopore flow cell also includes a first structure having the nanopore aperture; a second structure adjacent the first structure, the second structure includes a first opening that defines a portion of the cell reservoir and a second opening that defines a portion of the fluid flow channel; a third structure adjacent the second structure, the third structure having the electrode disposed thereon and an opening for the fluid flow channel. A portion of the cell reservoir is defined on a first side by the first structure and another portion of the cell reservoir is defined on a second side by the third structure. A portion of the fluid flow channel is defined on a first side by the first structure. A fluid can flow through the openings of the fluid flow channel into the fluid flow channels and into the cell reservoir.

One such method for analyzing a lipoprotein, among others, includes a nanopore analysis system as described above; introducing a target lipoprotein to the cell reservoir via the fluid flow channel; applying a voltage gradient to the nanopore analysis system; translocating the target lipoprotein through the nanopore aperture; and monitoring the signal corresponding to the movement of the target lipoprotein with respect to the nanopore aperture.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

Reference is now made to the following drawings. Note that the components in the drawings are not necessarily to scale.

FIG. 1 is a schematic of an exemplary lipoprotein.

FIG. 2 is a schematic of an embodiment of a nanopore analysis system.

FIGS. 3A and 3B are diagrams of representative nanopore devices that can be used in the nanopore analysis system of FIG. 2.

FIGS. 4A and 4B are diagrams of representative nanopore flow cells and can be used in the nanopore analysis system of FIG. 2.

FIG. 5 is a diagram of a representative array of nanopore flow cells.

FIG. 6 is a diagram of a representative array of nanopore flow cells.

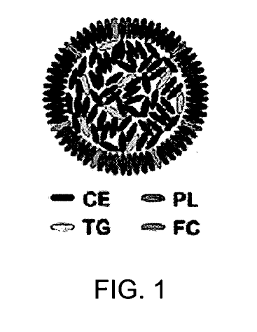

### DETAILED DESCRIPTION

Definition

A “lipoprotein” refers to any organic compound that includes both protein and various fatty substances classed as lipids, including fatty acids and steroids such as cholesterol. Each lipoprotein is a particle with the hydrophobic lipids in the center and a coating of polar lipids and apoproteins.

The term “organic” refers to a composition that contains a carbon basis.

The term “inorganic” refers to a composition that does not contain a carbon basis.

Discussion

The “Coulter Principle” establishes a reference method for counting and sizing particles. The Coulter Principle refers to detecting and sizing a particle by flowing it through a small aperture filled with electrolyte. The particle displaces the electrolyte. The volume of electrolyte displaced is detected as a voltage pulse, and the height (or depth) of the pulse is proportional to the volume of the particle. The disclosed systems and methods apply the Coulter Principle to size lipoproteins using a nanopore. The nanopore flow cell systems that can be used in nanopore size fractioning of lipoproteins can also be used to determine the size of lipoproteins. Exemplary nanopore flow cell systems are described in, for example, U.S. Pat. No. 5,795,782 to Church et al. and U.S. Pat. No. 6,015,714 to Baldarelli et al., both of which are incorporated herein by reference,

In a cell or particle counting system, the aperture is on the order of 100 micron in diameter. The nanopores used for DNA sizing applies the same principle, but dramatically scales down the pore to about 4 nm or smaller in diameter. In order to size and count lipoproteins, a pore on the order of, for example, 100 nm is appropriate. The pore can also be of a size of about 75-100 nm, 30-90 nm, 25-30 nm, 20-23 nm, or 5-20 nm.

To use the disclosed lipoprotein size fraction assay system, a blood sample is obtained from a patient, typically by venipuncture. Using well-known technology, the sample is spun to obtain the serum portion of the blood. The sample may be further filtered to remove any large chylomicrons. The sample is sufficiently diluted in electrolyte to allow the lipoproteins to move through the pore individually. As each particle moves through the pore, it displaces the electrolyte. The resulting electrical pulse (or current blockage) is counted and its height (or depth) is noted.

A sufficient number of particles are moved through the pore to ensure that the results are statistically significant. The results are reported as the number of particles in each size range. The amount of sample moved through the device and its dilution are noted to calculate the concentration of each particle size in the original sample. The disclosed systems and methods of assaying lipoprotein size fractions involve minimal sample preparation and no labeling.

In an alternative embodiment, the sample may be moved through a series of pores which are ordered in size with the largest pore first and decreasing the pore size to obtain more precise information about the size distribution of the smaller particles.

As will be described in greater detail here, nanopore analysis systems incorporating nanopore flow cell systems, are provided. By way of example, some embodiments provide for a plurality of structures that include openings for fluid to flow once the structures are secured to one another. The openings can include, but are not limited to, fluid flow channels, reservoirs, and the like. The fluid flow channels can be used to introduce fluids to the reservoirs from a fluid source within or outside of the nanopore analysis system. In one embodiment, the reservoir is in fluid communication with a nanopore aperture, where lipoproteins can, under proper conditions, interact with the nanopore aperture. In another embodiment, the fluid flow channels can be positioned so that the reservoir is filled from the bottom of the reservoir, which reduces the probability of air bubbles blocking a part or the entire nanopore aperture.

In general, nanopore size fractioning involves the use of two separate pools of a medium and an interface between the pools. The interface between the pools is capable of interacting sequentially with the individual lipoproteins present in one of the pools. Interface-dependent measurements are continued over time, as individual lipoproteins interact sequentially with the interface, yielding data suitable to infer a size characteristic of the lipoprotein.

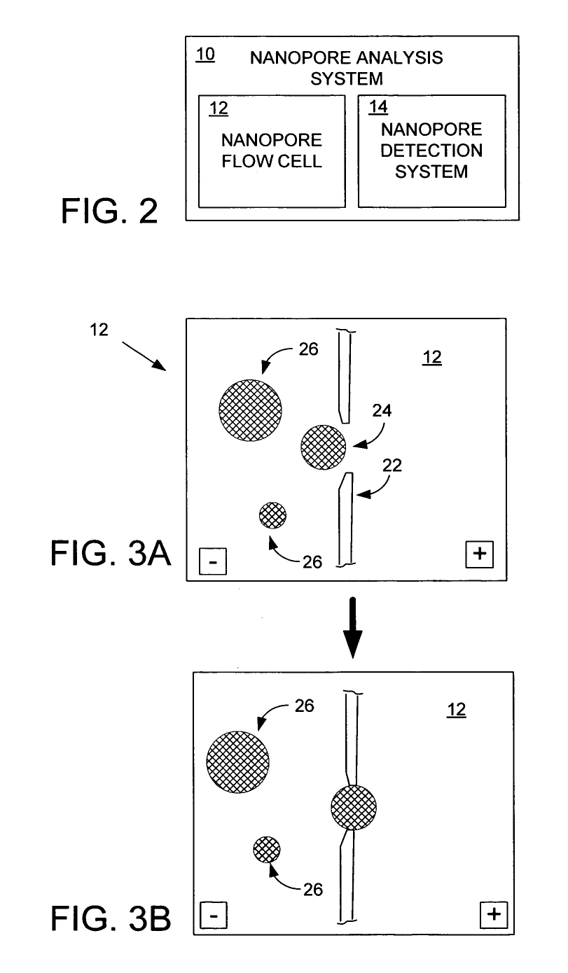

FIG. 2 illustrates a representative embodiment of a nanopore analysis system 10 that can be used in nanopore size fractioning. The nanopore analysis system 10 includes, but is not limited to, a nanopore flow cell 12 and a nanopore detection system 14. The nanopore flow cell 12 and the nanopore detection system 14 are communicatively coupled so that data regarding the target lipoprotein can be measured.

The nanopore detection system 14 may include, but is not limited to, electronic equipment capable of measuring characteristics of the lipoprotein as is interacts with the nanopore aperture, a computer system capable of controlling the measurement of the characteristics and storing the corresponding data, control equipment capable of controlling the conditions of the nanopore device, control equipment capable controlling the flow of fluids into and out of the nanopore flow cell 12, and components that are included in the nanopore device that are used to perform the measurements as described below.

The nanopore detection system 14 can measure characteristics such as, but not limited to, the amplitude or duration of individual conductance or electron tunneling current changes across the nanopore aperture. Such changes can identify the lipoprotein, as each lipoprotein has a characteristic conductance change signature. For instance, the volume, shape, or charges on each lipoprotein can affect conductance in a characteristic way. Likewise, the size of the lipoprotein can be determined by observing the length of time (duration) that lipoprotein-dependent conductance changes occur. Alternatively, the number of lipoproteins present in a solution can be determined as a function of the number of lipoprotein-dependent conductance changes for a given solution traversing the nanopore aperture. The number of lipoproteins may not correspond exactly to the number of conductance changes, because there may be more than one conductance level change as each lipoprotein of the solution passes sequentially through the nanopore aperture. However, there is proportional relationship between the two values that can be determined by preparing a standard with a lipoprotein having a known amount of lipoproteins present.

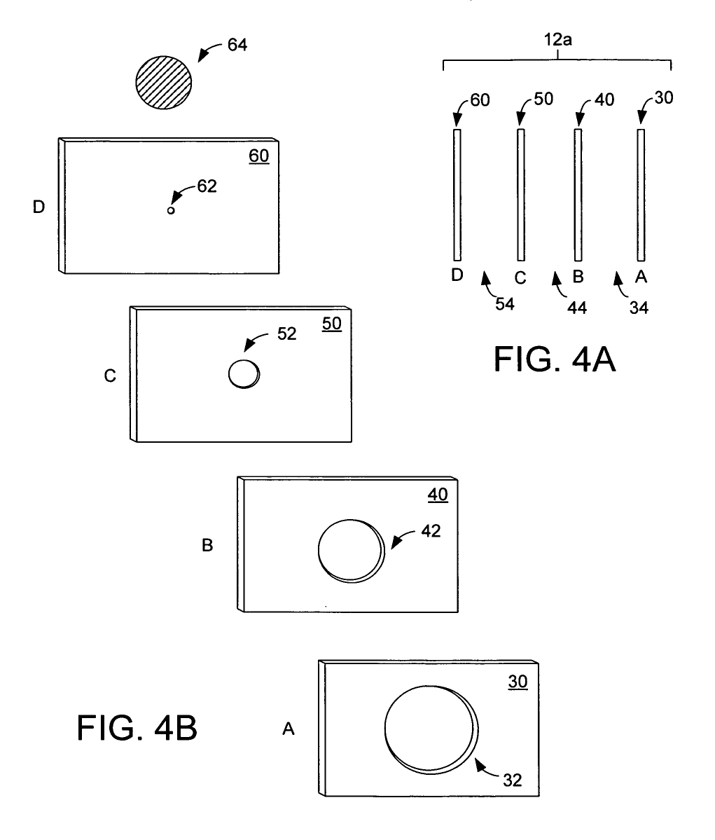

FIGS. 3A and 3B illustrate representative embodiments of the nanopore flow cell 12. The nanopore flow cell 12 includes, but is not limited to, a structure 22 that separates two independent adjacent pools of a medium (e.g., one pool being in the reservoir 34 and one pool being in reservoir 44 in FIG. 4A). The two adjacent pools are located on the “−” side and the “+” side of the nanopore flow cell 12. The structure 22 includes, but is not limited to, at least one nanopore aperture 24 (e.g., nanopore aperture 32, 42, 52, 62 in FIGS. 4A and 4B) so dimensioned as to allow fluid communication between the two adjacent pools. In one embodiment, the nanopore aperture 24 is dimensioned to allow lipoprotein 26 translocation (e.g., passage) from one pool to another by only one lipoprotein 26 at a time (or not at all, if the lipoprotein 26 is too large). The nanopore aperture 24 can further include detection components that can be used to perform measurements on the target lipoprotein as it passes through the nanopore aperture 24.

Exemplary detection components have been described in WO 00/79257, which is incorporated herein by reference in its entirety, and can include, but are not limited to, electrodes directly associated with the structure 22 at or near the pore aperture 24, and electrodes placed within the “−” and “+” pools. The electrodes may be capable of, but not limited to, detecting ionic current differences across the two pools or electron tunneling currents across the nanopore aperture 24.

As the lipoprotein translates through or passes sufficiently close to the nanopore aperture 24, measurements (e.g., ionic flow measurements, including measuring duration or amplitude of ionic flow blockage) can be taken by the nanopore detection system 14 as each of the lipoprotein passes through or sufficiently close to the nanopore aperture 24. The measurements can be used to identify the size and/or type of the lipoprotein.

The medium disposed in the pools on either side of the substrate 22 can be any fluid that permits adequate lipoprotein mobility for interaction with the structure 22. In one embodiment, the medium is an electrolyte that is sufficiently conductive to generate a signal as it flows past an electrode. For example, the electrolyte can be approximately 1 M KCl or NaCl solution, with a pH, for example, of about 8.2.

The target lipoprotein 26 being characterized can remain in its original pool, or it can cross the nanopore aperture 24 into the other pool. In either situation, as the target lipoprotein moves in relation to the nanopore aperture 24, individual lipoproteins 26 interact with the nanopore aperture 24 to induce a change in the conductance of the nanopore aperture 24. The nanopore aperture 24 is traversed by a lipoprotein translocation through the nanopore aperture 24 so that the lipoprotein passes from one of the pools into the other. In some embodiments, the lipoprotein is close enough to the nanopore aperture 24 for the lipoprotein to interact with the nanopore aperture 24 passage and bring about the conductance changes, which are indicative of lipoprotein characteristics. In one embodiment, the passage of the lipoprotein through aperture 24 blocks the normal current flowing between the electrodes. The amount of current blocked and/or the length of time the current is blocked (e.g., transit time of the lipoprotein 26 through the aperture 24) can be related to information regarding the size and/or type of the lipoprotein. For example, a large diameter lipoprotein A will give more current blockage than a smaller diameter lipoprotein B. Therefore, it can be determined that lipoprotein A is larger than lipoprotein B. Using a set of standard measurements for known lipoproteins, the amount of current blockage, or the length of time the current is blocked, gives information about the precise type of lipoprotein(s) in a sample (e.g., VLDL (very low density lipoprotein), IDL (intermediate density), LDL (low density), HDL (high density), and subclasses each).

Now having described the nanopore flow cell 12 in general, FIGS. 4A and 4B illustrate additional optional features of the nanopore flow cell 12. The entire nanopore flow cell 12 is not depicted in FIGS. 4A and 4B, but rather one side of the nanopore flow cell 12. The remaining portions of the nanopore flow cell 12 are referred to elsewhere herein, for example. In short, once the target lipoprotein(s) translate(s) through the nanopore aperture 24, the fluid on the “−” side of the nanopore flow cell 12 is discarded or further treated.

FIG. 4A is a cross-sectional view of a portion (i.e., the “+” side) of the nanopore flow cell 12, while FIG. 4B illustrates a perspective view of the same portion of the nanopore flow cell 12 as shown in FIG. 4A. The nanopore flow cell 12 includes, but is not limited to, a first nanopore aperture 32, a second nanopore aperture 42, a third nanopore aperture 52, and a fourth nanopore aperture 62. In the illustrated embodiment, each of the nanopore apertures 32, 42, 52, 62 is of a different size and/or shape compared to each other. The sizes and/or shapes of the nanopore apertures 32, 42, 52, 62 are configured to sort the lipoproteins by type. Each of the nanopore apertures 32, 42, 52, 62 is in fluid communication with each other.

The nanopore flow cell 12 includes, but is not limited to, a first structure 30, a second structure 40, a third structure 50, and a fourth structure 60. The first structure 30 includes the nanopore aperture 32. The second structure 40 is adjacent the first structure 30. The second structure 40 includes a second aperture 42. The third structure 50 is disposed between the second structure 40 and a fourth structure 60. The third structure 50 includes the third aperture 52 in fluid communication with the second aperture 42. The fourth structure 60 is adjacent the third structure 50. An electrode 64 (e.g., a silver/silver chloride electrode or the like) is disposed in-line with the apertures 32, 42, 52, 62 (e.g., all or a portion of the electrode 64 is exposed to the apertures 32, 42, 52, 62. Although the embodiment depicted in FIGS. 4A and 4B depicts four structures with four different-sized apertures, a different number (e.g., two, three, five, six, seventy, one hundred, etc.) of structures and other sizes/shapes of apertures can be utilized in the nanopore flow cell 12.

In other words, the first structure 30, the second structure 40, the third structure 50, and the fourth structure 60 are aligned and form a part of the nanopore flow cell 12. The apertures form the flow channels of the nanopore flow cells in which fluids and samples flow. The first structure 30, the second structure 40, the third structure 50, and the fourth structure 60, can be secured in alignment by physical (e.g., mechanical (e.g., screws), heat and/or pressure, and the like) and/or chemical (e.g., adhesives and the like) securing mechanisms.

Disposed between the structures 30, 40, 50, 60 can be reservoirs 34, 44, 54. In particular, a portion of the cell reservoir 34 is defined on a first side by the first structure 30 and another portion of the cell reservoir 34 is defined on a second side by the second structure 40. Similarly, the second structure 40 and the third structure 50 define a portion of a cell reservoir 44. The cell reservoir 54 is defined on a first side by the third structure 50 and on a second side by the fourth structure 60. In addition, the lipoprotein sample fluid flows through the aperture 32 in the first structure 30 and the apertures 42, 52, 62 from an appropriate fluid or sample introduction system (not shown).

A lipoprotein sample or other fluid can flow into and/or out of the cell reservoirs 34, 44, 54 via one or more of the apertures 32, 42, 52. In one embodiment, the structures 30, 40, 50 have one or more optional additional openings and/or flow channels. The apertures 32, 42, 52, 62 and optional openings/channels for the fluid flow can be reversibly opened and closed to facilitate proper flow into and out of the cell reservoirs 34, 34, 44. In another embodiment, some of the apertures or openings may not be present to facilitate proper flow into and out of the cell reservoirs.

Each of the nanopore apertures 32, 42, 52, 62 be of a different size and/or shape than one or more of the other apertures. For example, the nanopore analysis system may include a plurality of apertures in series, with the size of each aperture being progressively smaller than the preceding aperture. By way of further example, but not limited to these examples, the nanopore aperture 32 can have a diameter of about 25 to 100 nanometers. The nanopore aperture 42 can have a diameter of about 22 to 24 nanometers. The nanopore aperture 52 can have a diameter of about 20 to 22 nanometers. The nanopore aperture 62 can have a diameter of about 4 to 20 nanometers. In one embodiment, the nanopore apertures 42, 52, 62 are consecutively smaller, with the size depending on the type of lipoprotein(s) being fractionated.

The first structure 30, the second structure 40, the third structure 50, and the fourth structure 60 can each have similar lengths, heights, and/or widths. In addition, the width can vary across a single structure. Each of the first structure 30, the second structure 40, the third structure 50, and the fourth structure 60, can have a different lengths, heights, and/or widths. For example, the second structure 40 and/or the third structure 50 can each have a width to define a specific volume of the cell reservoir 44. In this way, the nanopore flow cell 12 can be reconfigured or modified by the addition or removal of structures to produce nanopore flow cells with different dimensions, fluid flow channels, and the like. The widths for each of the first structure 30, the second structure 40, the third structure 50, and the fourth structure 60, can be selected based on the configuration needed for a particular application.

The first structure 30, the second structure 40, the third structure 50, and the fourth structure 60 can be made of materials such as, but not limited to, a silicon chip, silicon nitride, silicon oxide, mica, polyimide, stainless steel, and/or polymer. Other materials for the structures 30, 40, 50, and 60 can also be used.

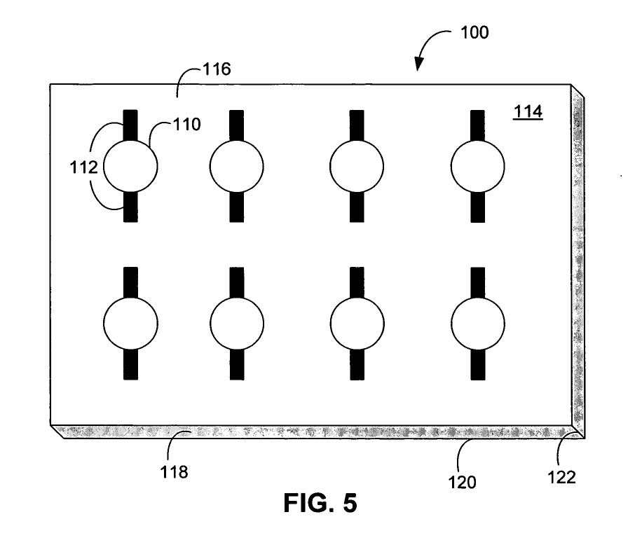

Also disclosed are arrays of nanopores designed for size fractioning of lipoproteins. One embodiment of a disclosed lipoprotein size fraction array 100 is illustrated in FIG. 5. The array 100 includes a plurality (e.g., more than one, or a multitude) of nanopores 110, each of which is addressed by its own electrodes 112. The nanopores 110 can be housed in a structure 114 that includes a first layer 116 through which the nanopores are disposed. The first layer 116 is exposed on a first surface to a first pool of fluid (e.g., a “−” pool) into which a sample of lipoproteins can be introduced. The first layer 116 is exposed on a second surface to a second pool 118 of fluid (e.g., a “+” pool) into which, if appropriately sized, the lipoproteins can be translocated. The second pool 118 is bounded on the other size by a second layer 120 of the structure 114, the first layer 116 and the second layer 118 forming part of an enclosure 122 for the second pool.

Although FIG. 5 depicts eight nanopores as an illustration, it should be noted that any other number of nanopores can be employed. In addition, although FIG. 5 depicts each of the nanopores 110 of approximately the same size, in other embodiments, each nanopore can be sized differently, or areas of the array 100 can have groupings of nanopores of one size while a different area of the array 100 can have groupings of nanopores of a different size. By measuring the signals from the electrodes as particles pass through the nanopores and analyzing the signals, information can be determined about the particles. For example, by analyzing the signals from the electrodes, a particle size distribution profile can be obtained. In addition, by comparing data of one or more particles with known size with data from a particle of an unknown size, the relative or exact size of the unknown particle can be determined.

Lipoproteins can be added to the individual nanopores 110 on the array 100 via drop-on-demand or electronically-controlled drop ejecting device such as with piezo- or thermal-activated drop generator (e.g., ink-jet device). A drop-on-demand device can be adapted to efficiently distribute very small amounts of a lipoprotein sample to precisely known locations on the array 100. Alternatively, or in addition, a lipoprotein sample can be pipetted onto the array 100. The sample can be delivered to the entire array of nanopores via a fluidic or microfluidic chamber or channel. Alternatively, separate microfluidic chambers may deliver separate samples to each nanopore.

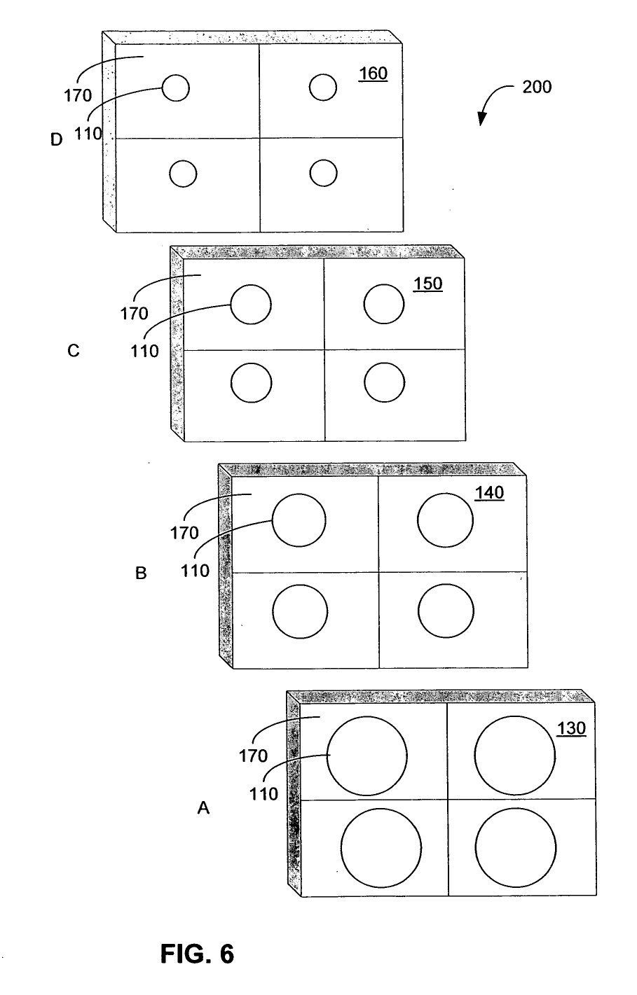

One embodiment of a disclosed lipoprotein size fraction array 200 is illustrated in FIG. 6. The array 200 includes a plurality (e.g., more than one, or a multitude) of structures A-D, wherein each of the structures includes an associated membrane 130, 140, 160, 160. Each of the membranes includes a plurality of nanopores 110, with each nanopore being associated with a specific region 170. The regions 170 of each membrane are aligned. Each membrane includes nanopores that are of a different size than the membrane(s) disposed adjacent it. For example, the nanopores of first membrane 130 are larger than those of second membrane 140; those of second membrane are larger than those of third membrane 150, and so on. Disposed between the membranes 130, 140, 150, 160 can be reservoirs for a lipoprotein-containing fluid, as disclosed above with respect to FIGS. 4A and 4B. Therefore, the size fractioning described above with respect to FIGS. 4A and 4B can also be applied to an array.

A. Characteristics Identified by Nanopore Size Fractioning

1) Size/Type of Lipoproteins

The size or type of a lipoprotein can be determined by measuring its residence time in the pore or channel, e.g., by measuring duration of transient blockade of current. The relationship between this time period and the size (e.g., diameter) of the lipoprotein can be described by a reproducible mathematical function that depends on the experimental condition used. The function is likely a linear function for a given type of lipoprotein (e.g., VLDL (very low density lipoprotein), IDL (intermediate density), LDL (low density), HDL (high density), and subclasses each), but if it is described by another function (e.g., sigmoidal or exponential), accurate size estimates may be made by first preparing a standard curve using known sizes of like molecules.

2) Identity of Lipoproteins

The chemical composition, size, and/or density of individual lipoproteins is sufficiently variant to cause characteristic changes in channel conductance as each lipoprotein traverses the pore due to physical configuration, size/volume, charge, interactions with the medium, etc. The lipoprotein will influence pore conductance during traversal, but if the single channel recording techniques are not sensitive enough to detect differences between the various lipoproteins in a sample, it is practical to supplement the system's specificity by using modified lipoproteins, e.g., tagging or chemically modifying a specific lipoprotein so that it can be detected.

3) Concentration of Lipoproteins in Solutions

Concentration of lipoproteins can be rapidly and accurately assessed by using relatively low resolution recording conditions and analyzing the number of conductance blockade events in a given unit of time. This relationship typically will be linear and proportional (the greater the concentration of lipoproteins, the more frequent the current blockage events), and a standardized curve can be prepared using known concentrations of lipoproteins.

B. Principles and Techniques

1) Recording Techniques

The disclosed conductance monitoring methods rely on an established technique, single-channel recording, which detects the activity of molecules that form channels in biological membranes. When a voltage potential difference is established across a bilayer containing an open pore molecule, a steady current of ions flows through the pore from one side of the bilayer to the other. The lipoprotein, for example, passing through or over the opening of a channel protein, disrupts the flow of ions through the pore in a predictable way. Fluctuations in the pore conductance caused by this interference can be detected and recorded by conventional single-channel recording techniques. Under appropriate conditions, with modified lipoproteins if necessary, the conductance of a pore can change to unique states in response to the specific lipoproteins.

This flux of ions can be detected, and the magnitude of the current describes the conductance state of the pore. Multiple conductance states of a channel can be measured in a single recording as is well known in the art.

The monitoring of single ion channel conductance is an inexpensive, viable method that has been successful for the last two decades and is in very widespread current use. It directly connects movements of single ions or channel proteins to digital computers via amplifiers and analog to digital (A to D, A/D) converters. Single channel events taking place in the range of a few microseconds can be detected and recorded (Hamill et al., 1981, Pfluegers Arch. Eur. J. Physiol., 391: 85-100). This level of time resolution ranges from just sufficient to orders of magnitude greater than the levels desired, since the time frame for movement of lipoprotein relative to the pore for the size fractioning method is in the range of microseconds to milliseconds. The level of time resolution required depends on the voltage gradient. Other factors controlling the level of time resolution include medium viscosity, temperature, pressure, etc.

The characteristics and conductance properties of any pore molecule that can be purified can be studied in detail using art-known methods (Sigworth et al., J. Biophys., 52:1055-1064, 1987; Heinemann et al., 1988, Biophys. J., 54: 757-64; Wonderlin et al., 1990, Biophys. J., 58: 289-97). These optimized methods can be used for the disclosed lipoprotein size fractioning application. For example, in the pipette bilayer technique, an artificial bilayer containing at least one pore protein is attached to the tip of a patch-clamp pipette by applying the pipette to a preformed bilayer reconstituted with the purified pore protein in advance. Due to the very narrow aperture diameter of the patch pipette tip (2 microns), the background noise for this technique is significantly reduced, and the limit for detectable current interruptions is about 10 microseconds (Sigworth et al., supra; Heinemann et al., 1990, Biophys. J., 57:499-514). Purified channel protein can be inserted in a known orientation into preformed lipid bilayers by standard vesicle fusion techniques (Schindler, 1980, FEBS Letters, 122:77-79), or any other means known in the art, and high resolution recordings are made. The membrane surface away from the pipette is easily accessible while recording. This is important for the subsequent recordings that involve added lipoproteins. The pore can be introduced into the solution within the patch pipette rather than into the bath solution.

An optimized planar lipid bilayer method has recently been introduced for high-resolution recordings in purified systems (Wonderlin et al., supra). In this method, bilayers are formed over very small diameter apertures (10-50 microns) in plastic. This technique has the advantage of allowing access to both sides of the bilayer, and involves a slightly larger bilayer target for reconstitution with the pore protein. This optimized bilayer technique is an alternative to the pipette bilayer technique.

Instrumentation is needed which can apply a variable range of voltages from about +400 mV to −400 mV across the channel/membrane, assuming that the “+” compartment is established to be 0 mV; a very low-noise amplifier and current injector, analog to digital (A/D) converter, data acquisition software, and electronic storage medium (e.g., computer disk, magnetic tape). Equipment meeting these criteria is readily available, such as from Axon Instruments, a subsidiary of Molecular Devices, Sunnyvale Calif. (e.g., Axopatch 200 A system; pClamp 6.0.2 software).

Preferred methods of large-scale lipoprotein size fractioning involve translating from individual lipoproteins to electronic signals as directly and as quickly as possible in a way that is compatible with high levels of parallelism, miniaturization, and manufacture.

2) Channels and Pores Useful in the Invention

Any channel protein or chemical or biological pore that has the characteristics useful in the invention (e.g., pore sized up to about 100 nm) may be employed. Physical pores are synthetic pores, such as those synthesized from, for example, silicon or silicon nitride. Chemical or biological pores are pores that exist in nature. An alpha-hemolysin pore is an example of a biological pore that can be used in the disclosed nanopore device. Pore sizes across which lipoproteins can be drawn may be quite small and do not necessarily differ for different polymers. Pore sizes through which a lipoprotein is drawn will be e.g., approximately 70-100 nm for a single lipoprotein. These values are not absolute, however, and other pore sizes might be equally functional for the lipoproteins mentioned above.

A modified voltage-gated channel can also be used in the invention, as long as it does not inactivate quickly, e.g., in less than about 500 msec (whether naturally or following modification to remove inactivation) and has physical parameters suitable for e.g., polymerase attachment (recombinant fusion proteins) or has a pore diameter suitable for lipoprotein passage. Methods to alter inactivation characteristics of voltage gated channels are well known in the art (see e.g., Patton, et al., Proc. Natl. Acad. Sci. USA, 89: 10905-09 (1992); West, et al., Proc. Natl. Acad. Sci. USA, 89: 10910-14 (1992); Auld, et al., Proc. Natl. Acad. Sci. USA, 87: 323-27 (1990); Lopez, et al., Neuron, 7: 327-36 (1991); Hoshi, et al., Neuron, 7: 547-56 (1991); Hoshi, et al., Science, 250: 533-38 (1990), all hereby incorporated by reference).

Appropriately sized physical or chemical pores may be induced in a water-impermeable barrier (solid or membranous) up to a diameter of about 100 nm, which should be large enough to accommodate most lipoproteins (either through the pore or across its opening). Any methods and materials known in the art may be used to form pores, including ion beam sculpting, track etching, and the use of porous membrane templates which can be used to produce pores of the desired material (e.g., scanning-tunneling microscope or atomic force microscope related methods).

C. General Considerations for Conductance Based Measurements

1) Electrical/Channel Optimization

A channel in a nanopore in a solid-state membrane separates two solution filled compartments, labeled “−” and “+”. Electrodes are used to apply a voltage across the membrane. In response to this voltage, the lipoproteins are added to the “−” compartment and the lipoproteins are pulled, one at a time, into and through the channel. The biased electrodes sense how lipoprotein translocation through the nanopore alter the pore's electrical properties. Ionic conductivity can be measured. The nanopore with suitably placed electrodes can be considered a “lipoprotein transistor” in which a lipoprotein molecule serves as the “gate.”

The conductance of a pore at any given time is determined by its resistance to ions passing through the pore (pore resistance) and by the resistance to ions entering or leaving the pore (access resistance). When a pore's conductance is altered, changes in one or both of these resistance factors can occur in measurable unit values. The individual type of lipoprotein molecule represents a discrete unit value of resistance that is distinct from other types of lipoproteins. As long as the membrane potential does not change, as each lipoprotein passes by (or through) the pore, it is likely to interfere with a reproducible number of ions. Modifications made to the individual lipoproteins would influence the magnitude of this effect.

Since channel events can be resolved in the microsecond range with the high resolution recording techniques available, the limiting issue for sensitivity with the disclosed techniques is the amplitude of the current change between lipoproteins.

Resolution limits for detectable current are in the 0.2 pA range (1 pA=6.24×10⁶ ions/sec). Each lipoprotein that affects pore current by at least this magnitude is detected as a separate lipoproteins. It is the function of modified lipoproteins to affect current amplitude for specific lipoproteins if the unmodified lipoproteins by themselves are poorly distinguishable.

One skilled in the art will recognize that there are many possible configurations of the size fractioning method described herein. For instance, lipid composition of the bilayer may include any combination of non-polar (and polar) components that are compatible with pore. Any configuration of recording apparatus may be used (e.g., bilayer across aperture, micropipette patches, intra-vesicular recording) so long as its limit of signal detection is below about 0.5 pA, or in a range appropriate to detect lipoproteinic signals of the lipoproteins being evaluated. If lipoprotein size determination is all that is desired, the resolution of the recording apparatus can be lower.

A Nernst potential difference, following the equation
Eᵢₒₙ=(RT/zF)logₑ([ion]ₒ/[ion]ᵢ),
where Eᵢₒₙ is the solvent ion (e.g., potassium ion) equilibrium potential across the membrane, R is the gas constant, T is the absolute temperature, z is the valency of the ion, F is Faraday's constant, [ion]ᵢ is the outside and [ion]ᵢ is the inside ionic concentration (or + and − sides of the bilayer, respectively), can be established across the bilayer to force lipoproteins across the pore without supplying an external potential difference across the membrane. The membrane potential can be varied ionically to produce more or less of a differential or “push.” The recording and amplifying apparatus is capable of reversing the gradient electrically to clear blockages of pores caused by secondary structure or cross-alignment of charged lipoproteins.

2) Optimization of Methods

In a disclosed operating system, one can demonstrate that the number of transient blockades observed is quantitatively related to the number of lipoprotein molecules that move through the channel from the −0 to the +compartment. By sampling the +compartment solution after observing one to several hundred transient blockades, it is possible to measure the number of lipoproteins that have traversed the channel.

Further steps to optimize the method can include:
a. Slowing the passage of lipoproteins so that individual lipoproteins can be sensed. Since each lipoprotein occupies the channel for just a few microseconds, blockage durations are observed in the microsecond range. To measure effects of individual lipoproteins on the conductance, substantially reducing the velocity may offer substantial improvement. Approaches to accomplish this include, for example: (a) increasing the viscosity of the medium, and (b) establishing the lower limit of applied potential that will move lipoproteins into the channel. In addition, in one embodiment, the passage of the lipoproteins through the pore is slowed to the point that the lipoprotein can interact with, or attach to a side of, the nanopore.
b. Enhancing movement of lipoproteins in one direction. Directionality of movement of the lipoproteins through the nanopore can be regulated through voltage and the bias placed on the electrodes.
c. Neutralizing surfaces of the pores so that any naturally occurring particles in the sample would not interfere with charge transfer. After, for example, ion beam sculpting, the chemical makeup of the pores may be or become charged, even if the charge is ever so slight. The surfaces of the pores can be neutralized with a buffer, or by treating the pores. For example, by employing atomic layer deposition for coating inorganics (e.g., AlO₃) or by employing molecular layer deposition (e.g. SiO₂) then the outer layer of the pore would be known, even after sculpting.

It should be emphasized that many variations and modifications may be made to the above-described embodiments. All such modifications and variations are intended to be included herein within the scope of this disclosure and protected by the following claims.

We claim at least the following:

1. A nanopore analysis system, comprising:
a nanopore flow cell comprising
a first structure that separates two independent adjacent pools of a medium,
a first nanopore aperture through the first structure, the first nanopore aperture dimensioned to allow fluid communication between the two independent adjacent pools, and
an electrode adjacent and in electrical communication with the first nanopore aperture; and
a detection system designed to detect the size of the lipoproteins translocated through the first nanopore aperture.

2. The nanopore analysis system of claim 1, wherein the first nanopore aperture is approximately 100 nm across.

3. The nanopore analysis system of claim 1, wherein the first nanopore aperture is approximately 4 nm to 100 nm across.

4. The nanopore analysis system of claim 1, wherein the lipoprotein sizes detected correlate to at least one of the following types of lipoproteins: VLDL (very low density lipoprotein), IDL (intermediate density), LDL (low density), HDL (high density), and subclasses and combinations of each.

5. The nanopore analysis system of claim 1, further comprising a second structure adjacent the first structure,
wherein the second structure comprises a second aperture of a different size than the first aperture, and
wherein the first aperture and the second aperture are in fluid communication with each other.

6. The nanopore analysis system of claim 1, further comprising a plurality of structures adjacent and in line with the first structure,
wherein each one of the plurality of structures comprises an aperture of a different size than the first aperture and the other apertures of the plurality of structures, and
wherein the first aperture and the apertures of the plurality of structures are in fluid communication with each other.

7. The nanopore analysis system of claim 1, wherein surfaces of the first nanopore aperture have a substantially neutral charge.

8. The nanopore analysis system of claim 1, wherein surfaces of the nanopore aperture are treated via atomic layer deposition, molecular layer deposition or chemically modified.

9. The nanopore analysis system of claim 8, wherein the surfaces of the nanopore aperture are treated with layers that are at least one of the following: organic, inorganic, or combinations thereof.

10. A method for analyzing a lipoprotein, comprising:
providing a nanopore analysis system;
introducing a target lipoprotein to a nanopore flow cell in the nanopore analysis system;
applying a voltage gradient to the nanopore analysis system;
translocating the target lipoprotein through a nanopore aperture in the nanopore analysis system; and
monitoring a signal corresponding to the movement of the target lipoprotein with respect to the nanopore aperture.

11. The method of claim 10, wherein the nanopore aperture is approximately 4 nm to 100 nm across.

12. The method of claim 10, further comprising determining the size of the lipoprotein from the monitored signal corresponding to the movement of the target lipoprotein with respect to the nanopore aperture.

13. The method of claim 12, wherein the determined size of the lipoprotein corresponds to at least one of the following types of lipoproteins: VLDL (very low density lipoprotein), IDL (intermediate density), LDL (low density), HDL (high density), and subclasses and combinations of each.

14. The method of claim 10, wherein the nanopore analysis system comprises a plurality of apertures in series, wherein the size of each aperture is progressively smaller than the preceding aperture.

15. The method of claim 10, further comprising treating surfaces of the nanopore flow cell to render the surfaces of substantially neutral charge.

16. The method of claim 10, further comprising slowing the rate of translocation of the lipoprotein through the aperture.

17. The method of claim 16, further comprising slowing the rate of translocation of the lipoprotein through the aperture to a rate at which the lipoprotein interacts with a surface of the aperture.

18. An array for size fractioning of lipoproteins, the array comprising:
a structure including a first layer fluidly coupled to a second layer, the first layer comprising
a first surface exposed to a first pool of fluid into which a sample of lipoproteins can be introduced, and
a second surface exposed to a second pool of fluid into which lipoproteins can be translocated;
a plurality of nanopores through the first layer;
electrodes associated with each nanopore; and
a second layer, wherein the first layer and the second layer form part of an enclosure for the second pool.

19. An array for size fractioning of lipoproteins, the array comprising:
a plurality of structures;
an associated membrane disposed in each structure; and
a plurality of nanopores disposed through each membrane, wherein each membrane comprises nanopores that are of a different size than nanopores of membrane(s) disposed adjacent it; and
wherein each nanopore is associated with a specific region, and wherein the regions of each membrane are aligned.

20. The array of claim 19 wherein reservoirs are disposed between the membranes, wherein the reservoirs are configured to collect or retain a lipoprotein-containing fluid.
